(19) United States
(12) Patent Application Publication
(10) Pub. No.: US 2007/0147083 A1
(43) Pub. Date: Jun. 28, 2007

(54) Backlight module

(75) Inventor: Ping-Feng Hwang, Miao Li County (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/642,916

(22) Filed: Dec. 21, 2006

(30) Foreign Application Priority Data
Dec. 23, 2005 (TW) 94222531

(51) Int. Cl. F21V 7/04

(52) U.S. Cl. 362/613; 362/626; 362/628

(57) ABSTRACT

An edge-type backlight module is applied to a 10-inch to 26-inch liquid crystal displayer. The backlight module includes a wedge-shaped light guide plate, three lamps and a lamp reflective cover. The wedge-shaped light guide plate includes at least a side edge, a bottom surface and a light emitting surface. Pluralities of v-cut structures are formed on the bottom surface. The three lamps are disposed on the side edge of the wedge-shaped light guide plate. The lamp reflective cover surrounds the lamps, so that light beams generated by the lamps are reflected to the wedge-shaped light guide plate by the lamp reflective cover.

### BACKGROUND OF THE INVENTION

(1) Field of the Invention

The present invention generally relates to a backlight module, and particularly to an edge-type backlight module.

(2) Description of the Prior Art

Please refer to FIG. 1. A conventional edge-type backlight module 20 includes pluralities of layers of optical films 22, a light guide plate 23, a reflection plate 24, four lamps 25 and two reflective covers 26. The optical films 22 are disposed over the light guide plate 23. The light guide plate 23 is disposed over the reflection plate 24. Two lamps 25 are disposed on one side of the light guide plate 23. The other two lamps 25 are disposed on the other opposite side of the light guide plate 23. For example, the lamps 25 are cold cathode fluorescent lamps. The two reflective covers 26 are disposed on two sides of the light guide plate 23 respectively. Each reflective cover 26 surrounds two lamps 25. Scattering patterns 231 are formed on a bottom surface of the light guide plate 23 adjacent to the reflective plate 24. The scattering patterns 231 are made by stencil printing.

Light beams generated by the lamps 25 are able to enter the light guide plate 23 from two side edges of the light guide plate 23. Then, the light beam uniformly emits out of the light guide plate 23 through the scattering patterns 231. The uniformity of the light beam is enhanced by adjusting the density of the scattering patterns 231. For example, The scattering patterns 231 adjacent to the lamps 25 are arranged in low density. The scattering patterns 231 far from the lamps 25 are arranged in high density. As a result, the uniformity of illumination of a whole liquid crystal panel is consistent. The optical films 22, for example, including an upper diffusion film, a lower diffusion film, an upper brightness enhancement film and a lower brightness enhancement film are used for enhancing the uniformity of the light beams provided by the backlight module 20.

The backlight module 20 having pluralities of lamps are often applied to a liquid crystal displayer larger than 10 inches. The brightness of each lamp 25 is about 30000 to 50000 cd/m². After the light beam generated by the four lamps 25 transmits through the light guide plate 23 and the optical films 22, the total brightness is about 5200 nits. Therefore, the brightness of the backlight module 20 of a liquid crystal displayer shown in FIG. 1 is about 5200*7%=364 nits. The light transmission ratio of a display panel in a general liquid crystal displayer is 7%.

Researchers in the relative field of the backlight module 20 are devoted to reducing components, assembling processes and time. For example, the researchers are devoted to reducing the lamps 25, the reflective covers 26 and the positioning devices thereof. The researchers are also devoted to reducing wire arrangement, wires, welding and the assembling processes. As a result, the cost of the backlight module 20 is lowered, and the backlight module 20 is more competitive in the industry.

### SUMMARY OF THE INVENTION

An objective of the present invention is to reduce components of a backlight module, for lowering the cost of the backlight module.

Another objective of the present invention is to provide an edge-type backlight module applied to a 10-inch to 26-inch liquid crystal displayer.

An edge-type backlight module of the present invention includes a wedge-shaped light guide plate, three lamps and a lamp reflective cover. The wedge-shaped light guide plate includes at least a side edge, a bottom surface and a light emitting surface. Pluralities of v-cut structures are formed on the bottom surface. The three lamps are disposed on the side edge of the wedge-shaped light guide plate. The lamp reflective cover surrounds the three lamps, so that light beams generated by the three lamps are reflected to the wedge-shaped light guide plate by the lamp reflective cover.

These and other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

The present invention will now be specified with reference to its preferred embodiment illustrated in the drawings, in which

FIG. 1 illustrates a conventional edge-type backlight module; and

FIG. 2 illustrates an edge-type backlight module according to the invention.

### DESCRIPTION OF THE PREFERRED EMBODIMENT

Please refer to FIG. 2. An edge-type backlight module 30 according to the present invention is applied to a 10-inch to 26-inch liquid crystal displayer, such as a desktop liquid crystal displayer or a liquid crystal display television. The backlight module 30 provides a uniform surface light source for a liquid crystal panel. The backlight module 30 includes pluralities of optical films 32, a wedge-shaped light guide plate 33, a reflection plate 34, three lamps 35 and a reflective cover 36. The optical films 32 are disposed over the light guide plate 33. The reflection plate 34 is disposed under the wedge-shaped light guide plate 33. The wedge-shaped light guide plate 33 includes at least a side edge 332, a bottom surface 333, and a light emitting surface 334. The bottom surface 333 and the light emitting surface 334 are two opposite surfaces of the wedge-shaped light guide plate 33. The reflection plate 34 is adjacent to the bottom surface 333. The optical films 32 are adjacent to the light emitting surface 334. The lamps 35 are disposed on the side edge 332 of the wedge-shaped light guide plate 33. All of the three lamps 35 are disposed on the same side edge 332. The thickness (d) of the side edge 332 is about 5˜12 mm. The lamp reflective cover 36 surrounds the three lamps 35, so that light beams generated by the lamps 35 are reflected to the wedge-shaped light guide plate 33 by the lamp reflective cover 36. Pluralities of v-cut structures 331 are formed on the bottom surface 333 of the wedge-shaped light guide plate 33. The v-cut structures are preferably made by machining, such as precision cutting or electroforming. The v-cut structures 331 and the wedge-shaped light guide plate 33 are formed integrally.

The light beam generated by the lamps 35 directly enters the wedge-shaped light guide plate 33 through the side edge 332. A portion of the light beam enters the wedge-shaped light guide plate 33 after reflected by the reflective cover 36. The v-cut structures 331 of the wedge-shaped light guide plate 33 enable the light beams to emit out of the wedge-shaped light guide plate 33 uniformly. The uniformity of the light beam is increased by adjusting the density of the v-cut structures 331. For example, the v-cut structures 331 adjacent to the lamps 35 are arranged in low density. The v-cut structures 331 far from the lamps 35 are arranged in is high density. As a result, the uniformity of the light beams of a whole liquid crystal panel is consistent. Furthermore, the light beam transmitting downward through the wedge-shaped light guide plate 33 is reflected toward the light emitting surface 334 by the reflection plate 34 adjacent to the bottom surface 33. Then, the light beam reflected by the reflection plate 34 emits out of the wedge-shaped light guide plate 33.

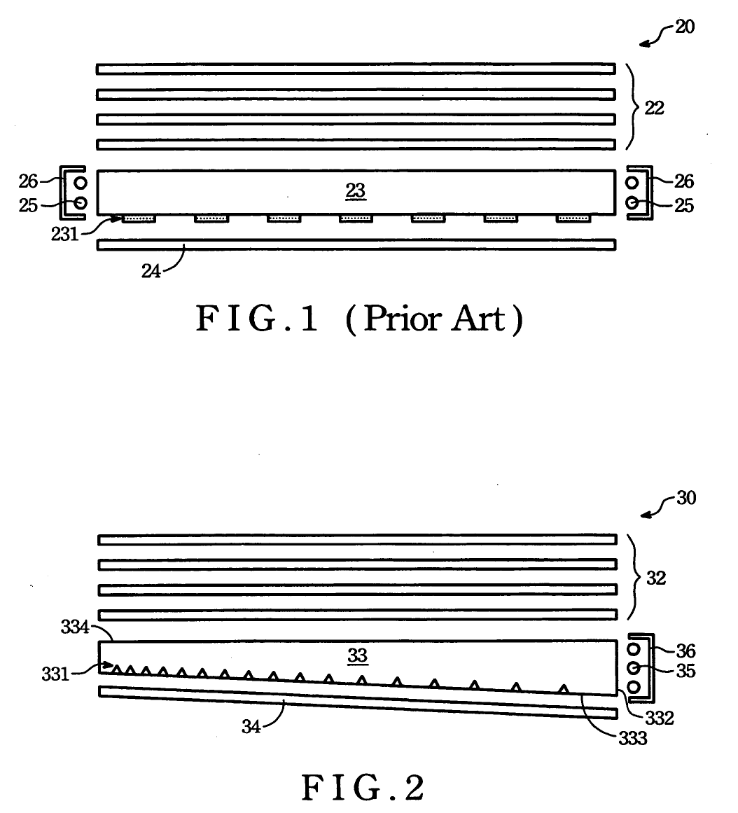

In the backlight module 30, the brightness of each lamp 35 is about 30000 to 50000 cd/m². After the light beam transmitting through the wedge-shaped light guide plate 33 and the optical films 32, the total brightness of the light beam generated by the three lamps 35 is about 4200 nits. Moreover, compared to the scattering patterns 231 in the prior art (as shown in FIG. 1), the v-cut structures 331 adopted by the present invention enhances the brightness enhancement effect by 20%. Therefore, the brightness of the backlight module 30 in a liquid crystal displayer is about 4200*7%*(1+0.2)=353 nits. The brightness value of the backlight module 30 meets the brightness value standard made by European union labor union for a liquid crystal displayer. Also, the brightness of the liquid crystal displayer with the backlight module 30 of the invention is really close to the brightness (364 nits) of the liquid crystal displayer using a conventional backlight module with two lamps on each side (the backlight module 20 shown in FIG. 1).

The lamps 35 and the reflective cover 36 are disposed on only one side edge 332 of the wedge-shaped light guide plate 33. Compared to the conventional backlight module 20 shown in FIG. 1, the backlight module 30 obviously reduces one lamp and one reflective cover. Besides, pluralities of assembling components used for disposing one lamp and one reflective cover are reduced as well. For example, the reduced assembling components are a positioning cover used for positioning the lamp, a positioning device of the reflective cover, and some connecting wires. Furthermore, an assembling process for disposing the lamp, the reflective cover and the assembling components is simplified. Additionally, the assembling time is reduced.

Therefore, the edge-type backlight module of the present invention obviously lowers the cost of the assembling components, simplifies the assembling process and reduces the assembling time. As a result, the backlight module 30 of the present invention not only decreases its own cost but also enables the product to be more competitive.

With the example and explanations above, the features and spirits of the invention are hopefully well described. Those skilled in the art will readily observe that numerous modifications and alterations of the device may be made while retaining the teaching of the invention. Accordingly, the above disclosure should be construed as limited only by the metes and bounds of the appended claims.

I claim:

1. An edge-type backlight module applied to a 10-inch to 26-inch liquid crystal displayer, the backlight module comprising:
a wedge-shaped light guide plate comprising a side edge, a bottom surface and a light emitting surface, a plurality of v-cut structures formed on the bottom surface;
three lamps disposed on the side edge of the wedge-shaped light guide plate; and
a lamp reflective cover surrounding the lamps, light beams generated by the lamps being reflected to the wedge-shaped light guide plate by the lamp reflective cover.

2. The backlight module of claim 1, wherein the v-cut structures and the wedge-shaped light guide plate are formed integrally.

3. The backlight module of claim 1, wherein a thickness of the side edge of the wedge-shaped light guide plate is between 5 mm and 12 mm.

4. The backlight module of claim 1 further comprising:
a plurality of optical films disposed over the wedge-shaped light guide plate adjacent to the light emitting plate; and
a reflection plate disposed under the wedge-shaped light guide plate adjacent to the bottom surface.
